(19) United States
(12) Patent Application Publication
(10) Pub. No.: US 2026/0125813 A1
(43) Pub. Date: May 7, 2026

(54) USE OF CO2-RICH FLUE GAS AS A SWEEPING GAS IN AN ELECTROLYSIS UNIT

(71) Applicant: Topsoe A/S, Kgs. Lyngby (DK)

(72) Inventor: Steffen Spangsberg CHRISTENSEN, Køge (DK)

(73) Assignee: Topsoe A/S, Kgs. Lyngby (DK)

(21) Appl. No.: 19/117,578

(22) PCT Filed: Dec. 14, 2023
(86) PCT No.: PCT/EP2023/085797

§ 371 Date: Apr. 1, 2025

(30) Foreign Application Priority Data
Dec. 21, 2022 (EP) 22215496.5

(51) Int. Cl. C25B 15/08; B01J 19/00; B01J 19/24; C01B 3/38; C25B 1/04; C25B 1/23; C25B 9/19

(52) U.S. Cl. CPC C25B 15/08; B01J 19/0013; B01J 19/24; C01B 3/38; C25B 1/04; C25B 1/23; C25B 9/19; B01J 2219/00033; B01J 2219/00087; B01J 2219/00157; C01B 2203/0227; C01B 2203/0827; C01B 2203/1235

(57) ABSTRACT

A gas heating section and a reforming section are provided, in which flue gas is used as an anode (oxygen) sweeping gas in an electrolysis unit. The resulting combined gas stream is fed to the gas heating section/reforming section as combustion gas stream. By continuously feeding the combined gas stream to said at least one burner and combusting it, a flue gas stream of high purity CO₂ can be obtained. A chemical plant, and a process for providing a syngas stream are also provided.

### TECHNICAL FIELD

The present invention relates to a gas heating section and—in particular—a reforming section, in which flue gas is used as an anode (oxygen) sweeping gas in an electrolysis unit. The resulting combined gas stream is fed back to the gas heating section/reforming section as combustion gas stream. By continuously feeding the combined gas stream to said at least one burner and combusting it, a flue gas stream of high purity CO₂ can be obtained. A chemical plant, and a process for providing a syngas stream are also provided.

### BACKGROUND

There is increasing interest in the use of electrolysis in industrial chemical plants and processes, to produce gas streams such as oxygen or hydrogen, especially in view of environmental concerns, and the increasing opportunities for using electricity from renewable sources.

The oxygen stream from industrial-scale electrolysis processes, such as those which take place in a solid oxide electrolyser cells (SOEC), is often considered as a waste product, and is simply vented to the atmosphere. If oxygen streams from such industrial-scale electrolysis processes are to be effectively used, a so-called “sweeping gas” (also called a “flushing gas” or “sweep gas”) is typically employed. The sweeping gas is passed into the anode-side of the electrolysis unit, where it mixes with the oxygen produced at the anode. The resulting combined gas stream containing oxygen is then outputted from the electrolysis unit. Use of a sweeping gas provides a combined gas stream at a pressure higher than that of the oxygen stream produced in the electrolysis unit, and can be used e.g. to adjust the chemical and physical composition of the oxygen stream, for a particular use. Use of a sweeping gas also improves safety by dilution of the oxygen gas.

Atmospheric air has typically been used as sweeping gas, and has the advantage of being readily-available. However, if the combined oxygen-containing gas stream from the electrolysis unit is recycled, the use of atmospheric air as sweeping gas leads to a build-up of inert nitrogen in the flue gas. Thus, when atmospheric air is used as sweeping gas in an electrolysis unit, it is required to subject the resulting flue gas to a CO₂ removal step, which is undesired, because a CO₂ removal unit is expensive. Thus, CO₂ to be sequestered must have a high level of purity to comply with governmental rules.

The use of carbon dioxide as a flushing gas is known from US2015038741 and WO2013/164172. U.S. Pat. No. 8,496,908 discloses a steam methane reforming process for producing a hydrogen product while capturing CO₂ from the process.

It is an object of the invention to provide effective re-use of flue gas streams from fired reformers and gas heaters, with the aim of reducing or removing the need for flue gas purification/scrubbing. It is also an object to provide effective sweeping of gases from electrolysis units. These and other objects are addressed by the present invention.

### SUMMARY

It has been found by the present inventor(s) that generation of pure oxygen in an electrolysis unit, and use of the flue gas from combustion as a sweeping gas provides synergy between the gas heating section/reforming section and the electrolysis unit. At the same time, a flue stream can be provided, being a high purity CO₂ stream. Thus, the present invention has provided a possibility of avoiding a step of subjecting the flue gas to a CO₂ removal step.

So, in a first aspect the present invention relates to a gas heating section, said gas heating section comprising a combustion chamber comprising at least one burner;
a heating chamber arranged in thermal communication with said combustion chamber,
an electrolysis unit;
a reactant feed to said electrolysis unit;
a fuel supply to said at least one burner;
a combustion gas stream to said at least one burner;
a first gas feed to said heating chamber;
wherein the combustion chamber is arranged to receive said fuel supply and said combustion gas stream and combust them in said at least one burner and thereby outlet a flue gas stream rich in carbon dioxide,
wherein said heating chamber is arranged to receive thermal energy from said combustion chamber and output a heated first gas stream,
wherein said electrolysis unit is arranged to electrolyse the reactant feed into at least an anode product gas;
and wherein
at least a first portion of said flue gas stream from the combustion chamber is arranged to be supplied to the anode of the electrolysis unit as a sweeping gas for said anode product gas, so as to output a combined gas stream comprising carbon dioxide and said anode product gas from said electrolysis unit;
and wherein at least a portion of said combined gas stream is arranged to be supplied to at least one burner of the combustion chamber as at least a portion of the combustion gas stream.

A reforming section is also provided, which comprises the gas heating section described herein, in which said first gas stream is a first hydrocarbon feed, and in which said heating chamber comprises a reforming catalyst, arranged to convert said first hydrocarbon feed into a syngas stream.

A chemical plant, preferably a hydrogen plant, is provided, which comprises the gas heating section described herein, or the reforming section described herein.

Further a process for providing a syngas stream in a reforming section according to the invention is provided.

Further details of the technology are provided in the enclosed dependent claims and figures.

### LEGENDS

The technology is illustrated by means of the following schematic illustration(s), in which:

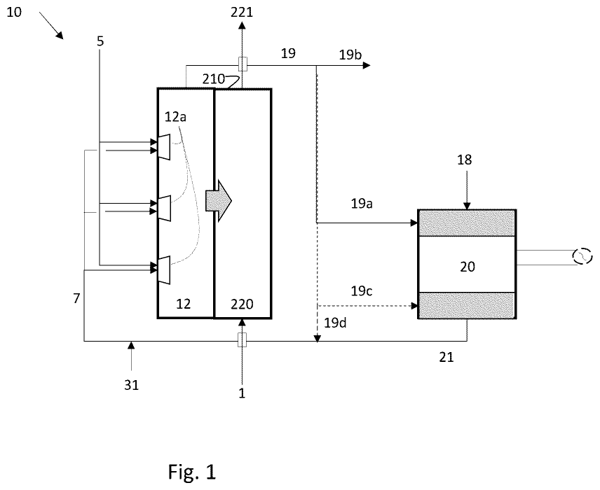

FIG. 1 shows a gas heating section according to the invention

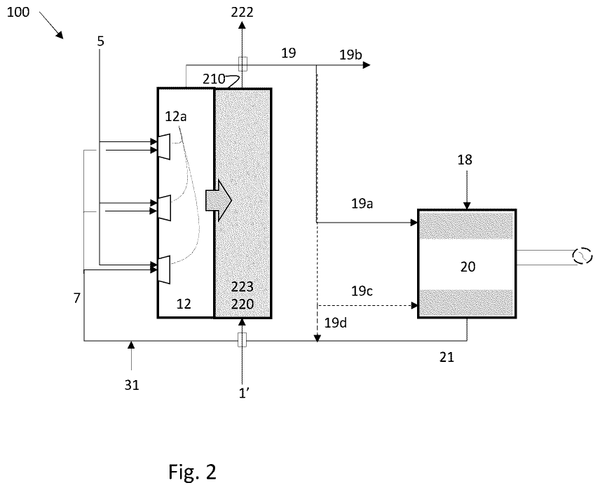

FIG. 2 shows a reforming section according to the invention

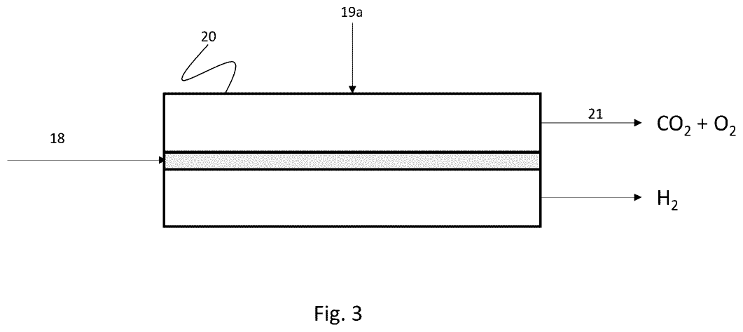

FIG. 3 shows an SOEC with sweeping gas input, according to the invention

### DETAILED DISCLOSURE

Unless otherwise specified, any given percentages for gas content are % by volume.

For the avoidance of doubt, the term “feed” refers to means for supplying said gas to the appropriate section, stage, reactor or unit; such as a duct, tubing etc.

The term “synthesis gas” (abbreviated to “syngas”) is meant to denote a gas comprising hydrogen, carbon monoxide, carbon dioxide, steam and small amounts of other gasses, such as argon, nitrogen, methane, etc.

The term “sweeping gas” means a gas supplied to the electrolysis unit for use as a carrier for carrying O2 out from the electrolysis unit, and the chemical components of the sweeping gas are not subjected to any chemical reaction or conversion during passage through the electrolysis unit.

Normally, reformers or fired heaters use air for combustion. This introduces a large amount of nitrogen in the flue gas, making downstream processing steps (e.g. CO₂ capture) necessary.

The present technology addresses at least two problems with a single solution-effective use of a flue gas from a reformer/fired heater, and effective sweeping of oxygen from an electrolysis unit.

In a first aspect, a gas heating section is provided, as illustrated generally in FIG. 1. The gas heating section comprises, in general terms:
a combustion chamber comprising at least one burner;
a heating chamber arranged in thermal communication with said combustion chamber,
an electrolysis unit;
a reactant feed to said electrolysis unit;
a fuel supply to said at least one burner;
a combustion gas stream to said at least one burner
a first gas feed to said heating chamber.

### Combustion Chamber

The combustion chamber defines a contained volume within a housing in which combustion of the fuel takes place. A fuel supply is provided to the at least one burner, housed within the combustion chamber. The fuel supply is typically a hydrocarbon-rich gas, such as natural gas. A combustion gas stream is also provided to the at least one burner. The combustion gas stream comprises an oxidant (e.g. oxygen) together with which, the fuel supply can be combusted.

The combustion chamber is arranged to receive the fuel supply and the combustion gas stream and combust them in said at least one burner and outlet a flue gas stream. The flue gas stream is CO2-rich (i.e. it comprises more than 50% CO₂, preferably more than 75% CO₂, more preferably more than 90% CO₂). After a number of recycles, the flue gas stream can comprise more than 99% CO₂.

A skilled engineer can design the combustion chamber and the burners as required, to achieve optimal combustion and heating.

If the oxygen content of the combustion gas stream is not sufficient, additional oxygen may be added. In one aspect, therefore, an oxygen-rich top-up feed is also arranged to be supplied to the at least one burner, preferably in admixture with the combined gas stream.

The fuel supply to the combustion chamber can be purified as required, prior to being fed to the combustion chamber.

### Heating Chamber

A heating chamber is arranged in thermal communication with the combustion chamber. The heating chamber is arranged to receive thermal energy from said combustion chamber and output a heated first gas stream. The heating chamber defines a contained volume within a housing in which heating of the first gas feed takes place. The relative arrangements of heating and combustion chambers may be designed by the skilled person. A suitable arrangement is a shell-tube reactor, in which the heating chamber comprises one or more tubes are arranged within the combustion chamber shell, or vice-versa.

A first gas feed is provided to the heating chamber, where it is heated. The heating chamber is thus arranged to receive thermal energy from said combustion chamber and output a heated first gas stream.

### Electrolysis Unit

An electrolysis unit is arranged to electrolyse the reactant feed into at least an anode product gas. Preferably, the electrolysis unit is one or more solid oxide electrolyser cells (SOECs). SOEC design and construction is known e.g. from WO2013/164172, the contents of which are incorporated by reference. Alternatively, the electrolysis unit of the plant of the invention may be an alkaline electrolyser or a proton exchange membrane (PEM) electrolyser.

At least a first portion of the flue gas stream from the combustion chamber is arranged to be supplied to the anode of the electrolysis unit as a sweeping gas for said anode product gas (typically oxygen), so as to output a combined gas stream comprising carbon dioxide and said anode product gas from said electrolysis unit.

At least a portion of the combined gas stream is arranged to be supplied to at least one burner of the combustion chamber as at least a portion of the combustion gas stream.

### Reactant Feed

A reactant feed is fed to the electrolysis unit. The electrolysis unit is arranged to electrolyse the reactant feed into at least an anode product gas.

In one preferred aspect, the reactant feed is a water-rich feed and the electrolysis unit is arranged to electrolyse the reactant feed into oxygen as anode product gas and hydrogen as cathode product gas. In another aspect, the reactant feed is a CO₂-rich feed and the electrolysis unit is arranged to electrolyse the reactant feed into oxygen as anode product gas and carbon monoxide as cathode product gas.

The present technology allows for recycling of the flue gas as sweeping gas for the oxygen from the electrolysis unit. By continuously feeding the combined gas stream to said at least one burner and combusting it, a flue gas stream of high purity CO₂ (e.g. comprising >99% CO₂, preferably >99.9% CO₂) can be obtained. This can reduce the need for a costly CO₂ removal unit (e.g. an amine wash unit) on the flue gas stack.

It may be advantageous to purify the flue gas stream (either the entire flue gas stream, or the first portion thereof) before it is sent to the electrolysis unit. Flue gas from hydrocarbon combustion may comprise water, dust, metal ions and/or sulfides (e.g. H₂S).

The gas heating section may comprise one or more recycle compressors, e.g. in the first portion of the flue gas stream sent to the electrolysis unit, or in the combined gas stream outputted from the electrolysis unit.

The gas heating section may produce an excess of flue gas, i.e. more than is required for sweeping the anode of the electrolysis unit. A second portion of the flue gas stream may therefore be exported from the gas heating section. Preferably, this section portion is high-purity (>99%) CO₂.

In the case where the electrolysis is CO₂ electrolysis (i.e. where the reactant feed is a CO₂ feed), it maybe sourced from the flue gas stream. A third portion of the flue gas stream may thus be arranged to be provided as CO₂-rich feed to the electrolysis unit.

### Reforming Section

In one preferred embodiment, the gas heating section described herein may be used as a reforming section. A reforming section converts a hydrocarbon gas feed into synthesis gas (syngas) using a reforming catalyst. This process is endothermic.

In this embodiment, the reforming section comprises the gas heating section as described above, with certain additional components. In the reforming section, the first gas stream is a first hydrocarbon feed, and the heating chamber is a reforming reactor comprising a reforming catalyst arranged to convert the first hydrocarbon feed into a syngas stream.

In one aspect of the reforming section, the reforming reactor is a steam methane reforming (SMR) reactor, and a water-rich co-feed is supplied to the SMR reactor.

The invention also provides a process for providing a syngas stream in a reforming section as described herein, said process comprising the steps of:
providing the fuel supply and the combustion gas stream to the combustion chamber and combusting them in said at least one burner and thereby outletting a flue gas stream rich in carbon dioxide,
electrolysing the reactant feed in said electrolysis unit into at least an anode product gas, preferably being oxygen;
supplying at least a first portion of said flue gas stream from the combustion chamber to the anode of the electrolysis unit as a sweeping gas for said anode product gas, so as to output a combined gas stream comprising carbon dioxide and anode product gas from said electrolysis unit;
supplying at least a portion of said combined gas stream to at least one burner of the combustion chamber as at least a portion of the combustion gas stream; and
allowing thermal energy to flow from the combustion chamber to the reforming reactor and converting said first hydrocarbon feed to a syngas stream, in said reforming reactor.

Preferably, in this process, the flue gas stream is continuously recycled as sweeping gas for the oxygen, and fed as the combined gas stream to said at least one burner and combusted, until a flue gas stream comprising >99% CO₂, preferably >99.9% CO₂ is obtained.

In a further embodiment, a chemical plant, preferably a hydrogen plant is provided, which comprises the gas heating section as described herein, or the reforming section as described herein.

In a particular aspect of the chemical plant, the reactant feed is a water-rich feed and the electrolysis unit is arranged to electrolyse the reactant feed into oxygen as anode product gas and hydrogen as cathode product gas, and wherein the hydrogen cathode product gas is supplied as feed to at least one reactor in the chemical plant.

The present technology can be used to re-fit existing chemical plants which use fired heaters to provide heat or a fired reformer. Re-fitting in this manner can simultaneously increase hydrogen production for internal use in the plant, and reduce the need for CO₂ separation/capture at the flue. Such a re-fitting would comprise steps of replacing one or more fired heaters in an existing plant with one or more gas heating sections according to the present invention. Alternatively, or additionally, such a re-fitting would comprise replacement of one or more fired reformers in an existing plant with one or more reforming sections according to the invention.

Although the present invention is described with reference to a number of aspects and embodiments, the skilled person may combine such aspects and embodiments, within the scope of the appended claims. All documents referenced herein are incorporated by reference.

### Specific Embodiments

FIG. 1 shows a gas heating section (10). The details of FIG. 1 are as follows:
combustion chamber (12)
burners (12a);
heating chamber (220)
electrolysis unit (20);
reactant feed (18) to the electrolysis unit (20);
fuel supply (5) to the burners (12a);
combustion gas stream (7) to the burners (12a);
first gas feed (1) to the heating chamber (220);

The combustion chamber (12) receives the fuel supply (5) and combustion gas stream (7). These are combusted together in the burners (12a) and a flue gas stream (19) is outlet from the combustion chamber (12). Thermal energy (the large arrow) is transferred to the heating chamber (220) from the combustion chamber (12). The first gas feed (1) is thereby heated in the heating chamber (220) to output a heated first gas stream (221).

The reactant feed (18) is fed to electrolysis unit (20) where it is electrolysed into at least an anode product gas (typically oxygen). The cathode product gas is typically hydrogen. A first portion (19a) of the flue gas stream (19) from the combustion chamber (12) is supplied to the anode of the electrolysis unit (20) as a sweeping gas for said anode product gas. A combined gas stream (21) comprising carbon dioxide and said anode product gas is output from said electrolysis unit (20). At least a portion of the combined gas stream (21) is supplied to at least one burner (12a) of the combustion chamber (12) as at least a portion of the combustion gas stream (7).

A second portion (19b) of said flue gas stream (19) may be exported from the gas heating section (10). A third portion (19c) of the flue gas stream (19) may be arranged to be provided as CO₂-rich feed to the electrolysis unit. A fourth portion (19d) of the flue gas stream (19) may be arranged to be mixed with the combined gas stream (21) prior to said combined gas stream (21) being supplied to at least one burner (12a) of the combustion chamber (12).

FIG. 2 shows a reforming section (100) according to the invention. The reforming section (100) comprises the same components as the gas heating section (10) illustrated in FIG. 1, and components with the same reference number are as indicated in FIG. 1. In FIG. 2, the first gas stream (1) is a first hydrocarbon feed (1′), and the heating chamber (220) is a reforming reactor (223) comprising a reforming catalyst, arranged to convert said first hydrocarbon feed (1′) into a syngas stream (222).

FIG. 3 shows an SOEC (20) with reactant feed (18), sweeping gas input (first portion 19a of the flue gas stream) and combined gas stream (21) according to the invention.

A simulation has been made based on the gas heating section of FIG. 1.

| | STREAM | | | | | |
|---|---|---|---|---|---|---|
| | 19a | | 19b | | 21 | |
| COMP | Nm³/h | mole % | Nm³/h | mole % | Nm³/h | mole % |
| CO₂ | 219874 | 97.77 | 47179 | 97.77 | 172685 | 78.71 |
| H₂ | | | | | | |
| N₂ | 827 | 0.37 | 177 | 0.37 | 649 | 0.30 |
| O₂ | 4186 | 1.86 | 898 | 1.86 | 46048 | 20.99 |
| H₂O | 43530 | | | | 2 | |
| DRY | 224887 | 100 | 48254 | 100 | 219382 | 100 |
| TOTAL | 268417 | | 48254 | | 219384 | |
| MOLE WEIGHT | 39.56 | | 43.73 | | 41.44 | |

As can be seen, flue gas stream (19) from the burner(s) is a high-purity CO₂-stream, comprising 97.77% CO₂ and a minor amount of O₂. The flue gas stream is split into first portion (19a) and second portion (19b). The first portion (19a) is used as sweeping gas in the anode side of the SOEC (20), and the second portion (19b) is exported from the gas heating section (10). The outputted combined gas stream (21) comprises around 21 mol % oxygen and around 79 mol % CO₂, and very little else.

The oxygen content of this stream (21) is sufficiently high for it to be used as combustion gas stream (7) in the burner (12a). Additionally, the only other significant component in this stream (21) is CO₂, meaning that build-up of inert compounds, such as nitrogen, is reduced, and combustion of this stream in the burner results a high purity CO₂ stream.

1. A gas heating section, said gas heating section comprising
a combustion chamber comprising at least one burner;
a heating chamber arranged in thermal communication with said combustion chamber,
an electrolysis unit;
a reactant feed to said electrolysis unit;
a fuel supply to said at least one burner;
a combustion gas stream to said at least one burner;
a first gas feed to said heating chamber;
wherein the combustion chamber is arranged to receive said fuel supply and said combustion gas stream and combust them in said at least one burner and thereby outlet a flue gas stream rich in carbon dioxide,
wherein said heating chamber is arranged to receive thermal energy from said combustion chamber and output a heated first gas stream,
wherein said electrolysis unit is arranged to electrolyse the reactant feed into at least an anode product gas;
wherein at least a first portion of said flue gas stream from the combustion chamber is arranged to be supplied to the anode of the electrolysis unit as a sweeping gas for said anode product gas, so as to output a combined gas stream comprising carbon dioxide and the anode product gas from said electrolysis unit; and
wherein at least a portion of said combined gas stream is arranged to be supplied to at least one burner of the combustion chamber as at least a portion of the combustion gas stream.

2. The gas heating section according to claim 1, wherein the electrolysis unit comprises one or more solid oxide electrolyser cells.

3. The gas heating section according to claim 1, wherein a second portion of said flue gas stream is exported from the gas heating section.

4. The gas heating section according to claim 1, wherein an oxygen-rich top-up feed is also arranged to be supplied to the at least one burner.

5. The gas heating section according to claim 1, wherein the reactant feed is a water-rich feed and wherein said electrolysis unit is arranged to electrolyse the reactant feed into oxygen as anode product gas and hydrogen as cathode product gas.

6. The gas heating section according to claim 1, wherein the reactant feed is a CO₂-rich feed and wherein said electrolysis unit is arranged to electrolyse the reactant feed into oxygen as anode product gas and carbon monoxide as cathode product gas.

7. The gas heating section according to claim 1, wherein a third portion of the flue gas stream is arranged to be provided as CO₂-rich feed to the electrolysis unit.

8. The gas heating section according to claim 1, wherein a fourth portion of the flue gas stream is arranged to be mixed with the combined gas stream prior to said combined gas stream being supplied to at least one burner of the combustion chamber.

9. A reforming section comprising the gas heating section according to claim 1, in which said first gas stream is a first hydrocarbon feed, and in which said heating chamber is a reforming reactor comprising a reforming catalyst, arranged to convert said first hydrocarbon feed into a syngas stream.

10. The reforming section according to claim 9, wherein said reforming reactor is a steam methane reforming reactor, and wherein a water-rich co-feed is supplied to the SMR reactor.

11. A chemical plant comprising the gas heating section according to claim 1.

12. The chemical plant according to claim 11, wherein the reactant feed is a water-rich feed and wherein said electrolysis unit is arranged to electrolyse the reactant feed into oxygen as anode product gas and hydrogen as cathode product gas, and wherein the hydrogen cathode product gas is supplied as feed to at least one reactor in the chemical plant.

13. A process for providing a syngas stream in a reforming section according to claim 9, said process comprising the steps of:
providing the fuel supply and the combustion gas stream to the combustion chamber and combusting them in said at least one burner and thereby outletting a flue gas stream rich in carbon dioxide,
electrolysing the reactant feed in said electrolysis unit into at least an anode product gas;
supplying at least a first portion of said flue gas stream from the combustion chamber to the anode of the electrolysis unit as a sweeping gas for said anode product gas, so as to output a combined gas stream comprising carbon dioxide and anode product gas from said electrolysis unit;
supplying at least a portion of said combined gas stream to at least one burner of the combustion chamber as at least a portion of the combustion gas stream; and
allowing thermal energy to flow from the combustion chamber to the reforming reactor and converting said first hydrocarbon feed to a syngas stream, in said reforming reactor.

14. The process according to claim 13, wherein the flue gas stream is continuously recycled as sweeping gas for the oxygen, and fed as the combined gas stream to said at least one burner and combusted, until a flue gas stream comprising >99% CO₂ is obtained.
